(19) United States
(12) Patent Application Publication
(10) Pub. No.: US 2021/0046338 A1
(43) Pub. Date: Feb. 18, 2021

(54) AVALANCHE AIRBAG SYSTEM, CARRYING DEVICE COMPRISING AN AVALANCHE AIRBAG SYSTEM, AND METHOD FOR OPERATING AN AVALANCHE AIRBAG SYSTEM

(71) Applicant: Ortovox Sportartikel GmbH, Taufkirchen (DE)

(72) Inventor: Christian BIER, Miesbach (DE)

(21) Appl. No.: 16/964,993

(22) PCT Filed: Jan. 28, 2019
(86) PCT No.: PCT/EP2019/051982

§ 371 Date: Jul. 26, 2020

(30) Foreign Application Priority Data
Jan. 26, 2018 (EP) 18153628.5

(51) Int. Cl. A62B 33/00; A45F 3/04; A63B 29/02; H02K 11/00

(52) U.S. Cl. CPC A62B 33/00; A45F 3/04; A45F 2003/003; H02K 11/0094; A63B 29/02

(57) ABSTRACT

The invention relates to an avalanche airbag system (10), which comprises an airbag (14) and a filling device (20) for introducing ambient air into the airbag (14). The filling device (20) comprises a fan (16) with an electric motor (18), a first electric energy storage (22, 40), a second electric energy storage configured as capacitor (24), and a control device (26) for actuating the electric motor (18). The control device (26) is configured to detect an activating of a standby mode of the filling device (20) and, depending on the activating of the standby mode, to effect a charging of the capacitor (24) with electric energy originating from the first energy storage (22, 40). Moreover, the invention relates to a carrying device comprising such an avalanche airbag system (10) as well as a method for operating such an avalanche airbag system (10).

The invention relates to an avalanche airbag system comprising an airbag and a filling device for introducing ambient air into the airbag. The filling device comprises a fan with an electric motor, a first electric energy storage, and a second electric energy storage, which is configured as capacitor. Moreover, the filling device comprises a control device for actuating the electric motor. The invention also relates to a carrying device comprising such an avalanche airbag system and a method for operating such an avalanche airbag system.

Presently avalanche airbag systems are common, in which a cartridge filled with a pressurized gas for filling or inflating the airbag is used. In the case of a triggering of the avalanche airbag system, effected by a user of the avalanche airbag system a closure of the cartridge is pierced through, and the gas contained in the cartridge flows into the airbag. In doing so via a Venturi device, through which the gas is flowing, additionally ambient air can be sucked in and be introduced together with the gas from the cartridge into the airbag.

As a disadvantage of such avalanche airbag systems is to be regarded the circumstance that multiple triggering is not possible. Moreover, air transportation regulations in some countries do not permit carrying filled cartridges. It cannot be ruled out either that in the future also for even more countries more restrictive transportation regulations with regard to the carrying of gas cartridges will be effective. This is because the gas in the cartridge of presently available avalanche airbag systems is pressurized at up to 300 bar.

As alternative avalanche airbag systems therefore for several years also ones with an electrically operated filling device are available. In these a very powerful fan with an electric motor makes sure that the airbag is filled with ambient air within the time of five seconds after triggering. Electricity is provided to the electric motor by an electric energy storage.

Common electric energy storages in the form of lithium-ion accumulators, however, at temperatures of less than −10 degrees Celsius suffer a significant loss in performance, and at temperatures of below −20 degrees Celsius a proper functioning of such electric energy storages is hardly given anymore.

Due to the high requirements made on the triggering safety of an avalanche airbag system, which must be guaranteed also at temperatures of up to −30 degrees Celsius, therefore energy storages configured as lithium-ion accumulators are dimensioned much larger than this would be required at moderate temperatures. This leads to it that the avalanche airbag system becomes very heavy, whilst remaining prone to problems at very low temperatures. Additionally, the provision of large lithium-ion accumulators is cost-intensive.

Document EP 3 202 462 A1 describes an avalanche airbag system comprising an electrically operated inflation device, wherein for supply of a fan of the inflation device capacitors in the form of supercapacitors or ultracapacitors are employed. For recharging the capacitors the inflation device described in document EP 3 202 462 A1 can comprise a battery. The inflating of the airbag, however, is always and exclusively accomplished with the electric energy from the capacitors.

In this connection it is to be regarded as a disadvantage that capacitors show a comparatively fast self-discharge. If the avalanche airbag system of document EP 3 202 462 A1 thus is not being used during an extended period of time, ensuring the filling of the airbag with the electric energy remaining in the capacitors may become critical.

It therefore is the object of the present invention to improve an avalanche airbag system of the initially mentioned kind with regard to its triggering safety, to provide a carrying device with such an avalanche airbag system, and to provide a correspondingly improved method.

This object is solved by an avalanche airbag system having the features of claim 1, a carrying device having the features of claim 13, and a method having the features of claim 14. Advantageous embodiments with expedient further developments of the invention are indicated in the dependent claims.

The avalanche airbag system comprises at least one airbag and a filling device for introducing ambient air into the airbag. The filling device comprises at least one fan with an electric motor, a first electric energy storage, and a second electric energy storage, wherein the second electric energy storage is configured as capacitor. A control device of the filling device serves for actuating the electric motor. In this connection the control device is configured to detect an activating of a standby mode of the filling device and, depending on the activating of the standby mode, to effect a charging of the capacitor with electric energy originating from the first energy storage. The control device consequently ensures that the capacitor is not charged until immediately upon activation of the standby mode of the filling device by a user of the avalanche airbag system. In this way it is ensured that during a non-use of the avalanche airbag system as little as possible electric energy is lost.

This is based on the finding that capacitors due to a self-discharge continuously lose electric energy. The loss by this self-discharge can amount to at least five percent within 24 hours. This means for instance in the case of the avalanche airbag system of document EP 3 202 462 A1 that after a week, in which the avalanche airbag system or a backpack equipped with the avalanche airbag system is not in use, already more than one third of the electric energy of the capacitor has been lost. In order to make sure that the capacitor is fully charged, the user thus would have to recharge the capacitor after a certain period of non-use of the avalanche airbag system. This is inconvenient for the user or operator, and moreover it may also be critical for safety, if the user misses out on recharging the avalanche airbag system before a tour.

In the present case, however, the control device ensures that each time the filling device of the avalanche airbag system is brought into the standby mode or on-call service mode, the capacitor is charged with energy originating from the first electric energy storage. Thereby the user does not need to take care of the recharging of the capacitor, and yet the power, in particular the full power, of the capacitor is available after activating the standby mode of the filling device and the charging of the capacitor triggered thereby. The avalanche airbag system thus remains operational over a particularly extended period of time also without a recharging of the capacitor effected by the user. This raises the triggering safety of the avalanche airbag system, and it is moreover particularly convenient and low in expenditure for the user of the avalanche airbag system.

Moreover, the first energy storage nevertheless can be dimensioned to be lighter in weight and smaller than this would be the case when providing an energy supply that does not comprise the capacitor as the second electric energy storage. This is because such energy supply commonly is dimensioned very large in order to still provide sufficient electric energy for the inflating of the airbag also at temperatures of up to −30 degrees Celsius. By providing the capacitor the presently described avalanche airbag system, however, also functions at very low temperatures without power drop. This is because the capacitor is capable to provide a large amount of electric energy in a short period of time and in particular largely independently of the prevailing ambient temperature. This insensitivity to temperature of the capacitor compared to the first electric energy storage is made use of in the presently described avalanche airbag system.

This is because in the capacitor the electric energy can be stored and also be released again by the capacitor to a great extent independently of the prevailing ambient temperature. And by the resupplying of the electric energy, which is lost due to the self-discharge of the capacitor, immediately after the activating of the standby mode of the filling device the capacitor can particularly largely fulfill its function of providing electric energy for the electric motor of the fan.

In particular in the case of the possibly life-saving avalanche airbag system this is a big advantage. This is because the capacitor is employed in combination with the first electric energy storage for providing electrical energy to the electric motor of the fan, wherein the first electric energy storage is an energy storage that is different from a capacitor. By the use of both the first electric energy storage as well as the capacitor the filling device of the avalanche airbag system, however, is particularly lightweight. Moreover a lower nominal capacity of the electric energy storages of the filling device needs to be provided than this would be the case with a use of merely batteries or accumulators as single electric energy storage, if at the same time also at very low ambient temperatures the triggering of the airbag is to be ensured.

By providing both the first electric energy storage as well as the capacitor consequently on the whole a higher redundancy with regard to the providing of the electric energy for the electric motor is given, and thus a raised safety for the operator or user of the avalanche airbag system. In this connection the first electric energy storage is configured to release the electric energy stored in it over a longer period of time in comparison with the capacitor, whereas the capacitor is capable to release the electric energy within a very short period of time. The capacitor thus serves as an electric energy storage that can be used over a short period time and the first energy storage as an electric energy storage that can be used over a long period of time. This combination is particularly advantageous for the provision of electrical energy to the electric motor of the fan for inflating the airbag with ambient air. This is because the power requirement of both the electric motor as well as for instance the control device can be covered in a particularly targeted and efficient way.

By the fact that the first electric energy storage performs the charging or the recharging of the capacitor due to the activation of the standby mode, it can in particular be ensured that also in the case of non-use of the avalanche airbag system over a period of time of up to four weeks the capacitor is then operational, when the avalanche airbag system should be used and thus is brought into the standby mode by the user.

The filling device can for instance be brought into the standby mode by actuation of a switch, which can for instance be arranged on a handle or such an actuation device for triggering the avalanche airbag system. If the avalanche airbag system is arranged in a carrying device such as a backpack, such a switch for switching on the filling device and thus for activating the standby mode can also be arranged at a different suitable place in the backpack or on the backpack.

Preferably a nominal capacity of the first energy storage can be designed in such a way that also after charging the capacitor by using the electric energy of the first energy storage the airbag, in particular at an ambient temperature of up to −30 degrees Celsius can be filled at least once. Accordingly a single emergency triggering is also ensured by means of the first energy storage alone. This is beneficial to the safety of the avalanche airbag system.

Preferably the control device is configured to effect, depending on the activating of the standby mode, the introduction of at least one charge quantity from the first energy storage into the capacitor, by means of which the airbag can be filled at least once. In other words, it is thus preferred to shift the energy required for at least one triggering then into the capacitor, when the filling device is brought into the standby mode. In this way it can be made sure that during the use of the avalanche airbag system solely with the electric energy stored in the capacitor at least one triggering of the airbag is possible. This, too, increases the triggering safety of the avalanche airbag system.

Preferably the control device is configured to effect, depending on a being switched-on of the electric motor, the supplying of the electric motor with electric energy originating from both energy storages. This is based on the finding that in particular immediately after the switching-on of the electric motor a very large amount of power is to be made available by the energy storages. This is because at the very beginning of the filling operation a correspondingly high power of the fan is required in order to move the airbag out from an envelope enclosing the airbag, which upon arrangement of the avalanche airbag system in a carrying device such as a backpack is also referred to as airbag pocket. This is the case because by the fan the energy has to be procured to open this airbag pocket and to move the airbag out from the airbag pocket. For this purpose it makes sense if the electric motor is supplied with energy originating from both electric energy storages.

Moreover, when filling the airbag, it is to be ensured that the airbag is initially inflated at maximum power far enough for the airbag to have a certain volume occupied by the ambient air. Here, too, the use of the electric energy of both energy storages for provision to the electric motor is advantageous. Moreover at the very starting of the fan a particularly high power is to be made available by the electric motor.

And it can be particularly easily implemented in terms of control technology or closed-loop control technology that the control device invariably effects the supplying of the electric motor with electric energy originating from both energy storages each time the electric motor is switched on. Consequently the airbag or the avalanche airbag can be filled in an improved manner. The switching on of the electric motor can in particular be effected by actuating an actuation device or trigger device of the avalanche airbag system. Thus for instance as a consequence of a pulling of a triggering handle the control device can receive a signal and subsequently switch on the electric motor.

Preferably, the control device additionally or alternatively is configured to effect, depending on an exceeding of a predetermined threshold value of a power to be output by the electric motor when filling the airbag, a supplying of electric energy originating from both energy storages. This means that the nominal output to be provided by the electric motor can be taken into consideration in the decision by the control device whether both energy storages should provide electric energy to the electric motor or only one energy storage. In this way peak loads occurring when filling the airbag can be covered particularly well. Moreover, thus it can be ensured that under all conditions the high power of the energy storages is available to the electric motor.

The first electric energy storage in particular can comprise a non-rechargeable battery and/or an accumulator. The configuration of the first energy storage as non-rechargeable battery has the advantage that such electric energy storages also at low temperatures are more powerful than accumulators. Thereby the first electric energy storage in comparison with the configuration of same as accumulator can be dimensioned smaller and thus lighter in weight. Moreover, non-rechargeable batteries can easily and inexpensively be replaced, and no complex charging device needs to be provided, as it is the case with accumulators.

If the first electric energy storage by contrast comprises an accumulator, in particular electrical energy can be shifted back from the capacitor into the first electric energy storage. Therefore it has turned out to be advantageous if the control device of the filling device is configured to effect an introducing of electric energy from the capacitor into the first energy storage. Thus, in case the avalanche airbag system has not been triggered, a loss of energy due to the self-discharge of the capacitor can be counteracted if the filling device is switched off again, i. e. the standby mode is deactivated again.

Preferably it is envisaged that a replacement of the first energy storage without tool is possible. This simplifies the handling of the avalanche airbag system by the user.

Preferably the first energy storage serves for providing electric energy to the control device and/or to further electronic components. This is in particular then advantageous if the first energy storage is configured as non-rechargeable battery or as accumulator. This is because the power to be made available for provision to the control device as well as to further electronic components, which are active in the standby mode of the filling device, is comparatively low and in particular many times lower than the energy to be applied for operating the electric motor of the fan. This means that if it is not necessary to cover peak loads but rather to keep the filling device in the standby mode, it is advantageous to resort to the first energy storage that is configured as non-rechargeable battery or accumulator. This is because this ensures an efficient operation of the avalanche airbag system. Moreover, then the electric energy of the second energy storage serving as relief element is sustained and is largely unrestrictedly available for covering peak loads. The further electronic components can comprise in particular light sources or such display elements, which indicate the standby mode of the filling device and/or a charging state of the electric energy storages.

Preferably the capacitor is configured as supercapacitor or ultracapacitor. Additionally or alternatively the capacitor can be configured as lithium-ion capacitor. By means of the second energy storage configured as such a capacitor peak loads occurring during operation of the electric motor can be covered particularly well. This is because the supercapacitor or ultracapacitor and/or the lithium-ion capacitor can deliver its electric energy particularly fast. This is due to the power density for instance of a supercapacitor that is many times larger in comparison with an accumulator. Moreover the second energy storage configured as such a capacitor has the advantage that the capacitor also at very low and very high temperatures can easily provide its electric energy to the electric motor.

Capacitors for reasons of production can be subject to variations with regard to capacity and lifetime. If several capacitor elements of the capacitor are connected in series in order to form the capacitor of the filling device, preferably a monitoring unit is provided, which monitors the charging states of these capacitor elements and in particular balances differing charging states of the capacitor elements. In this way it is avoided that the weakest capacitor element determines the power of the capacitor.

The control device consequently can comprise the monitoring unit (or a management system of this kind), by means of which deficient states of the energy storages can be detected, and which in particular can be configured to protect the energy storage against overcharging and/or perform a charge balance between the energy storage units of the respective energy storage. This is advantageous for instance with regard to capacitor elements of the capacitor that are connected in series.

Preferably the capacitor is arranged on a printed circuit board and fixed in its position by means of a potting compound. In particular also the board or printed circuit board can be potted and/or painted. Moreover, the capacitor can be formed by a plurality of capacitor elements, which are electrically connected in series. By the involved design for a higher voltage the capacitor can provide a particularly large amount of electric energy.

By potting the capacitor elements of the capacitor and/or of further components on the printed circuit board it can be ensured that the capacitor is sufficiently vibration-proof and corrosion-proof and thus resists well the strains occurring during use of the avalanche airbag system.

Additionally for achieving a high vibration-resistance vibration-resistant plug-in connectors can be employed, a robust mechanical setup, a fixation of critical components, in particular by cast housings and/or a potting of these components, and the like.

For the vibration resistance it is moreover advantageous if the capacitor elements are accommodated to lie in a flat housing. In this way it can be ensured that a height of the housing is for instance at approximately 45 millimeters. By using such, flat components as well as the vibration-resistant plug-in connectors, a suitable design of the printed circuit board, the robust mechanical set-up, and in particular the fixation of critical components such as for instance the capacitor preferably the very high vibration-resistance is achieved. In this connection special cast housings can be provided, and preferably in particular the capacitor is fixed in its position by means of a potting compound. Also the printed circuit board can be potted and/or painted in order to raise the vibration-resistance of sensitive components of the filling device.

The high requirements as to vibration-resistance, as they in particular occur when transporting a backpack or carrying device of this kind comprising the avalanche airbag system in a vehicle and/or a helicopter, can thus be met.

A static charging of components of the avalanche airbag system or the filling device, as it is to be feared for instance when transporting the avalanche airbag system in a helicopter due to the rotation of the rotor blades of the helicopter, can be prevented to a particularly large extent by the fact that components such as for instance the electric motor, the control device, as well as further electronic components, keys or switches, and the like are connected with each other and lie on the same ground potential.

Moreover, the electronic components of the filling device, in particular of the control device, such as for instance microchips, integrated circuits, semi-conductors, and the like are preferably designed for a very wide operating temperature range, which in particular can range from −45 degrees Celsius to up to more than 100 degrees Celsius ambient temperature.

Preferably a housing of the filling device in which the electric energy storages are housed, is designed according to the protection class IP65 so that the housing with regard to the intrusion of foreign objects is dust-proof and protected against jet water.

Preferably the avalanche airbag system comprises an alarm device, which can be actuated by means of the control device and which is configured to request a user of the avalanche airbag system after a predetermined period of time has elapsed to recharge at least one of the energy storages and/or to replace at least one of the energy storages. For instance after about 24 hours the alarm device can request the user to recharge the capacitor. This, too, raises the triggering safety of the avalanche airbag system.

In particular if as the first energy storage a non-rechargeable battery is used, the user can be requested by means of the alarm device to exchange the battery, for instance after a triggering of the airbag or after an extended storage time of the avalanche airbag system. The alarm device can also request the user to recharge the first energy storage if same is configured as accumulator.

Preferably the avalanche airbag system comprises an actuation device, by means of which the filling device can be brought into the triggered state, in which the filling device introduces ambient air into the airbag. The actuation device can comprise a handle, which the user of the avalanche airbag system pulls in order to achieve the filling or the inflating of the airbag. In particular can a switching device be switched by means of the actuation device, wherein the control device receives a signal indicating that the switching device has been switched. Subsequently the control device by actuating the electric motor effects that the airbag is inflated.

In particular on the actuation device, for instance on the handle, moreover an indicator can be configured, which provides information about the charging state of the energy storages and/or about an operating state of the filling device. For instance the indicator can indicate that the filling device is in the on-call service mode or standby mode.

The switching device, which is switched by means of the actuation device, in order to trigger the airbag, is preferably designed to be discrete, i. e. it does without a microcontroller of its own. This is preferably equally the case with the preferably provided indicator elements, for instance in the form of light-emitting diodes or the like, which can indicate the state of the filling device and/or the charging state of the electric energy storage. Thereby, on the one hand, an electric energy consumption of these devices is kept particularly low. Moreover, a particularly high reliability is guaranteed.

The carrying device according to the invention, which can be configured for instance as carrying harness, in particular, however, as backpack, comprises an avalanche airbag system according to the invention. In this connection preferably the airbag or avalanche airbag is accommodated in an airbag pocket of the backpack. The airbag pocket is in the majority of cases a compartment or a container of this kind, which is separate from a further stowage compartment of the backpack and in which the airbag is stored to be protected against damage. Moreover the airbag pocket ensures that the airbag during standard use does not drop out from the backpack. At the same time the airbag should be packed as compactly as possible so as to avoid that unnecessarily precious backpack volume is taken up by the airbag. This purpose, too, is fulfilled by the airbag pocket. If, however, the avalanche airbag system is triggered, as a consequence of the inflating of the airbag the opening of the airbag pocket is effected so that the then released airbag can be filled further.

The method according to the invention for operating an avalanche airbag system comprising at least one airbag and a filling device, involves introducing ambient air into the airbag by means of the filling device. The filling device comprises at least one fan with an electric motor, a first electric energy storage, and a second electric energy storage, which is configured as a capacitor. Moreover the filling device comprises a control device, which actuates the electric motor. In this connection the control device detects an activating of a standby mode of the filling device. Due to the detection of the activating of the standby mode the control device effects a charging of the capacitor with electric energy originating from the first energy storage. Due to the fact that the electric energy thus is not shifted into the capacitor until the user switches the avalanche airbag system on and thus brings the filling device into the standby mode, losses in electric energy of the capacitor due to a self-discharge can be kept particularly low. This raises the triggering safety of the avalanche airbag system during its operation.

The advantages and preferred embodiments of the avalanche airbag system according to the invention also apply to the carrying device according to the invention and to the method according to the invention and vice versa.

The features and feature combinations mentioned above in the description as well as the features and feature combinations mentioned below in the description of figures and/or shown in the figures alone are usable not only in the respectively specified combination, but also in other combinations without departing from the scope of the invention. Thus, implementations are also to be considered as encompassed and disclosed by the invention, which are not explicitly shown in the figures and explained, but arise from and can be generated by the separated feature combinations from the explained implementations. Implementations and feature combinations are also to be considered as disclosed, which thus do not comprise all of the features of an originally formulated independent claim. Moreover, implementations and feature combinations are to be considered as disclosed, in particular by the implementations set out above, which extend beyond or deviate from the feature combinations set out in the back-references of the claims.

Further advantages, features, and details of the invention may be gathered from the claims, the following description of preferred embodiments as well as the drawings. These show in:

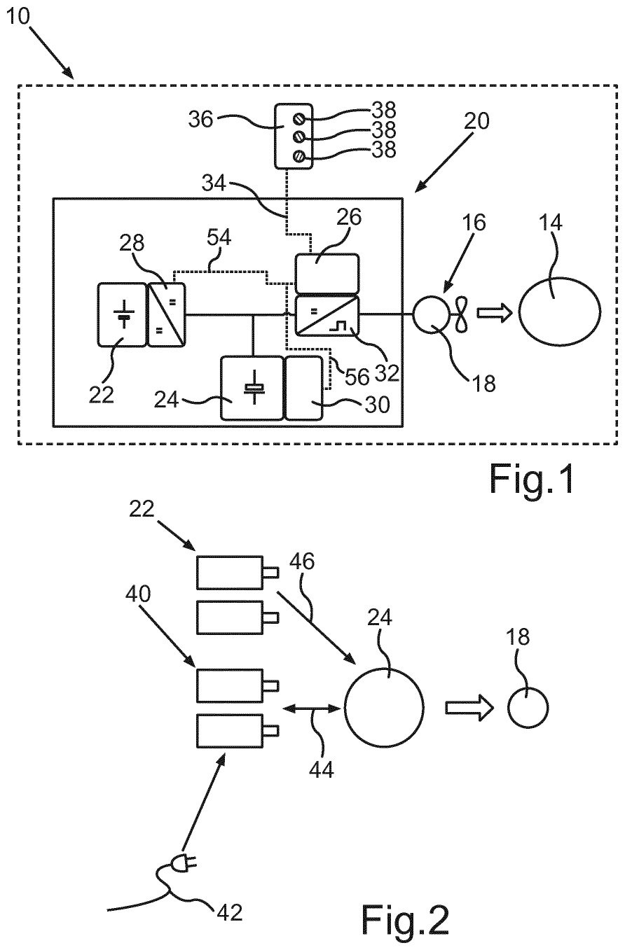

FIG. 1 schematically an avalanche airbag system, in which for supplying an electric motor of a fan a battery and a capacitor are employed, wherein by means of the fan an airbag or avalanche airbag is inflated;

FIG. 2 a variant of the avalanche airbag system, in which a charging of the capacitor via an external power grid is not envisaged, however the capacitor is recharged by the battery or an accumulator;

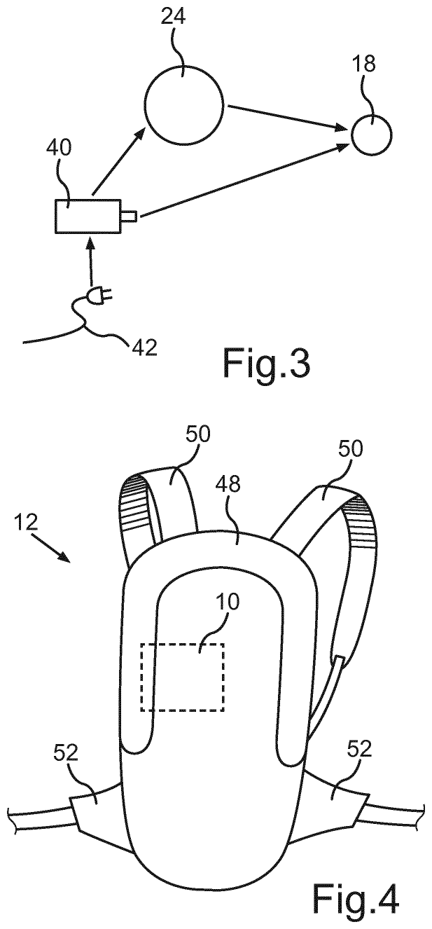

FIG. 3 a further variant, in which equally an accumulator can be used for charging the capacitor, wherein both the capacitor as well as the accumulator provide electric energy to the electric motor; and

FIG. 4 schematically an avalanche airbag backpack comprising the avalanche airbag system according to FIG. 1.

FIG. 1 schematically shows an avalanche airbag system 10, as it is provided for use in a carrying device for instance in the form of a backpack 12 (see FIG. 4). If the avalanche airbag system 10 is arranged in the backpack 12, the backpack 12 is an avalanche airbag backpack. A filling device 20 of the avalanche airbag system 10 in the present case is configured to fill an airbag 14 of the avalanche airbag system 10 with ambient air by operating a fan 16, wherein the fan 16 comprises an electric motor 18. By operating the fan 16 consequently after a triggering of the avalanche airbag system 10 it is ensured that the airbag 14 is filled with ambient air within about five seconds.

In particular at the very low ambient temperatures, at which the avalanche airbag system 10 can be employed, it is a challenge to ensure the provision of electric energy to the electric motor 18. In the present case according to FIG. 1 the filling device 20 of the avalanche airbag system 10 therefore comprises not only the fan 16, but also a first electric energy storage in the form of a battery 22 and a second electric energy storage in the form of a capacitor 24. The capacitor 24 can in particular be configured as supercapacitor or ultracapacitor in particular in the form of a double layer capacitor and/or as lithium-ion capacitor. Moreover, the capacitor 24 can comprise a plurality of capacitor elements in the form of supercapacitors or ultracapacitors or lithium-ion capacitor units that are preferably connected in series. Then the capacitor can provide a higher voltage than a single capacitor element is capable to provide.

A control device for instance in the form of an electronic control device 26 actuates the electric motor 18. In particular the control device 26 can ensure that both electric energy from the battery 22 as well as electric energy from the capacitor 24 is provided to the electric motor 18 in order to effect the inflating or the filling of the airbag 14 with ambient air.

The battery 22 can in particular be formed by at least two common, non-rechargeable battery cells (see FIG. 2), which can be electrically conductively connected with each other. In particular exactly two such battery cells can be envisaged for providing the battery 22. By means of a DC-DC converter 28 (see FIG. 1) the voltage provided by the battery 22 can be adjusted to the voltage provided by the capacitor 24.

If the battery 22 is formed by at least two non-rechargeable battery cells that are connected in series, preferably a capacity of the battery 22 is designed such that after a complete charging of the capacitor 24 and after 24 hours in the standby mode at least two, preferably three to four triggerings of the airbag 14 are possible.

Also in the case of a configuration of the first electric energy storage as accumulator 40 (see FIG. 2) corresponding, rechargeable accumulator cells can be connected in series and thus provide a higher voltage than the individual accumulator cell is capable to provide.

As has already been set out, in analogy to the battery 22 also the capacitor 24 can be formed by a plurality of capacitor elements or cells, which preferably in the same way as the battery cells are electrically connected in series. By means of a monitoring unit 30 assigned to the capacitor 24 differences in voltage between such capacitor units or capacitor elements can be identified and balanced. The control device 26 is configured for actuating the DC-DC converter 28 and the monitoring unit 30. Corresponding control lines 54, 56 are shown in FIG. 1. Moreover the control device 26 actuates a further converter 32, which for instance can be configured as inverter, and via which the electric energy originating from the battery 22 and the capacitor 24 is supplied to the electric motor 18.

Via a triggering line 34 the control device 26 is connected to a triggering handle 36 or such actuation device. For instance by pulling the triggering handle 36 the filling device 20 can be brought into a triggered state, in which the filling device 20 introduces ambient air into the airbag 14.

In the present case the capacitor 24 is charged by means of electric energy originating from the first electric energy storage, be it in the form of the battery 22 or the accumulator 40, as soon as a main switch of the avalanche airbag system 10 or the filling device 20 is actuated and thus the filling device 20 is brought into the standby mode. Moreover, both to ensure the charge conservation of the capacitor 24 as well as to provide electric energy to the control device 26 and further electronic components of the filling device 20 in the present case preferably that electric energy is used, which originates from the battery 22 (see FIG. 1) or from the battery 22 and the accumulator 40 (see FIG. 2).

If, however, the electric motor 18 of the fan 16 is operated in order to inflate the airbag 14, i. e. fill it with ambient air, then the capacitor 24 supports the battery 22 or the accumulator 40 in providing electric energy to the electric motor 18. In this way peak loads of the electric motor 18 can be covered particularly well. During the load consequently the battery 22 (or the accumulator 40) in a current-limited way provides its maximum electricity via the DC-DC converter 28 to the electric motor 18, wherein the remaining electric current provided to the electric motor 18 is made available by the capacitor 24.

On the triggering handle 36 display elements 38 can be arranged, which provide information about the charging state of the energy storage in the form of the battery 22 or the accumulator 40 and of the capacitor 24. For instance a light-emitting diode illuminating in yellow, one illuminating in red, and one illuminating in green can be provided as such display elements 38. Moreover, the display elements 38 can preferably indicate that the filling device 20 is switched on and is in the on-call service mode or standby mode.

By using non-rechargeable battery cells for providing the battery 22 the provision of energy also at very low temperatures is clearly more efficient than this would be the case when using the accumulator 40 as sole first energy storage. Moreover after the triggering of the airbag 14 the battery cells of the battery 22 can be replaced very easily by new battery cells. In order to further increase safety with regard to the inflating of the airbag 14, in the present case, however, the capacitor 24 is provided, which serves as relief element.

By such a relief element also peak loads in the operation of the electric motor 18 can be covered. Moreover the capacitor 24 is not sensitive to temperature so that by means of the capacitor 24 also at very low ambient temperatures large quantities of electric energy for operating the electric motor 18 can be made available very fast.

In particular it is envisaged that the control device 26 is provided with electricity by the battery 22. When operating the electric motor 18, by contrast, the capacitor 24 supports the battery 22. Preferably the battery 22 is designed such that at least a single triggering, i. e. at least a single filling of the airbag 14, is possible with the energy quantity stored in the battery 22 even at ambient temperatures of up to −30 degrees Celsius. Preferably, even if the battery 22 is formed by two common, non-rechargeable battery cells, it can be ensured that by means of the electric energy of the battery 22 the capacitor 24 can be completely charged four to five times. This is the case in particular when the shifting of electric energy from the battery 22 into the capacitor 24 takes place at temperatures of more than zero degree Celsius. If the capacitor 24 can be completely charged four times to five times, by means of the electric energy shifted into the capacitor 24 four to five triggerings of the avalanche airbag system 10 are possible, during which the airbag 14 is inflated.

The control device 26 can also ensure that the electric motor 18 is operated merely with the energy originating from the capacitor 24. In particular, however, it is envisaged that both the battery 22 as well as the capacitor 24 at least temporarily provide electric energy for operating the electric motor 18. This can be effected by the control device 26 for instance when the electric motor 18 is switched on or when the electric motor 18 is meant to provide a certain nominal power that is higher than a predetermined threshold value of the nominal power.

FIG. 2 schematically shows components of a variant of the avalanche airbag system 10. In this variant the first electric energy storage is formed both by the non-rechargeable battery 22 as well as by a rechargeable battery, i. e. an accumulator 40. In FIG. 2 schematically a charging cable 42 is shown, which can be connected to an external power grid, in order to charge the accumulator 40 via the grid for instance before a ski tour. On the side of the filling device 20 for connecting the charging cable 42 a suitable charging connection, for instance in the form of a USB connection, in particular a mini USB connection, is provided. Moreover, in FIG. 2 by a double arrow 44 it is indicated that the accumulator 40 can be employed for compensating for a self-discharge of the capacitor 24.

This compensating for the self-discharge of the capacitor 24 is equally possible with the battery 22 shown in FIG. 1. In order to facilitate the shifting back of electric energy from the capacitor 24 into the accumulator 40, as illustrated by the double arrow 44, the DC-DC converter 28 (see FIG. 1), which is not shown in FIG. 2, is preferably configured as bidirectional DC-DC converter 28.

Also in the variant shown in FIG. 2 both the accumulator 40 as well as the capacitor 24 can independently of each other provide electric energy to the electric motor 18. The control device 26, however, also in this variant can effect the supplying of electric energy originating both from the accumulator 40 and from the capacitor 24 to the electric motor 18.

Moreover, also in the variant shown in FIG. 2 it is envisaged that the battery 22 compensates for a self-discharge of the capacitor 24 serving in particular as relief element. However, no electric energy can be introduced from the capacitor 24 into the battery 22. Therefore in FIG. 2 instead of a double arrow between the battery 22 and the capacitor 24 merely an arrow 46 is shown, which illustrates the compensation for the self-discharge of the capacitor 24.

In the variant of the avalanche airbag system 10 shown in FIG. 2 the first energy storage of the filling device 20 is jointly formed by the battery 22 and the accumulator 40 (see FIG. 1). In the variant according to FIG. 2 it is not envisaged that the capacitor 24 is charged or recharged via the external power grid, i. e. by using the charging cable 42. Rather, merely the battery 22 and/or the accumulator 40 ensure the charging or recharging of the capacitor 24. In this way no separate charging device for the capacitor 24 needs to be provided and kept available.

In the case of the variants of the avalanche airbag system 10 described with reference to FIG. 1 and FIG. 2 the charging or recharging of the capacitor 24 is effected by the control device 26 each time the filling device 20 is brought into the standby mode. In this way losses in electric energy of the capacitor 24 due to the self-discharge are kept particularly low. In order to bring the filling device 20 into the standby mode, the avalanche airbag system 10 is switched on, and as a consequence electric energy is provided to the control device 26. When the filling device 20 is in the standby mode, the actuation of the triggering handle 36 (see FIG. 1) effects that the fan 16 fills the airbag 14 with ambient air. The control device 26 in this connection receives a signal indicating that the triggering handle 36 has been actuated and subsequently actuates the electric motor 18.

When switching on or activating the standby mode, the fan 16 can briefly be operated so that the user of the backpack 12 or the avalanche airbag system 10 receives a feedback to the effect that the standby mode is activated. However, there are also other ways in which an, in particular haptic feedback for this purpose can be generated, or it can be optically or acoustically communicated to the user that the standby mode of the filling device 20 has been activated.

Moreover it can be envisaged that, if the ambient temperature drops below a certain threshold value, electric energy is shifted from the battery 22 or from the accumulator 40 (see FIG. 2) into the capacitor 24. In this way the decreasing power of the accumulator 40 or battery 22 at low ambient temperature can be accommodated.

In FIG. 3 components of the avalanche airbag system 10 according to a further variant are shown from which it becomes clear that both by the accumulator 40 as well as by the capacitor 24 electric energy for the electric motor 18 can be made available. Also in the variant shown in FIG. 3 as in the variant according to FIG. 2 it is envisaged that the capacitor 24 is not recharged by connecting to an external power source. Rather, the charging of the capacitor 24 is effected by the accumulator 40. However, the accumulator 40 in turn can be charged via the charging cable 42 by connecting the charging cable 42 to the external power grid.

When inflating the airbag 14, the electric motor 18 of the fan 16 can initially be operated at maximum power in order to fill the airbag 14 with a certain volume of ambient air of for instance about 150 liters. In a further step then the pressure to be set in the interior of the airbag 14 can be built up, wherein for sustaining the pressure in particular a valve can be closed. For building up the pressure the electric motor 18 can be operated at a lower power than for inflating the desired volume. Moreover, it may be envisaged that for beginning the inflation operation the electric motor 18 is at least predominantly provided with electric energy from the capacitor 24. However, also at the beginning of the inflation operation additionally the battery power of the battery 22 or the accumulator 40 can be used.

In FIG. 4 it is schematically shown that the airbag 14 of the avalanche airbag system 10 can be arranged in an airbag pocket 48 of the backpack 12. Such an airbag pocket 48 in the present case is a compartment or a container of this kind, which is separate from a further stowage compartment of the backpack 12 and in which the airbag 14 is stored to be protected against damage. Moreover, the airbag pocket 48 ensures that the airbag 14 during standard use does not drop out from the backpack 12. At the same time the airbag 14 should be packed as compactly as possible to avoid precious backpack volume to be taken up unnecessarily by the airbag 14. Also this purpose is fulfilled by the airbag pocket 48. If the avalanche airbag system 10 is triggered, this effects the opening of the airbag pocket 48 as a consequence of the inflating of the airbag 14. Then the released or exposed airbag 14 can subsequently be filled further with ambient air by means of the fan 16.

Of the backpack 12 in FIG. 4 moreover shoulder straps 50 as well as waist straps 52 are schematically shown. The triggering handle 36 of the avalanche airbag system 10, which can in particular protrude from one of the shoulder straps 50, is not shown in FIG. 4 for the sake of clarity.

1. Avalanche airbag system (10) comprising at least one airbag (14) and a filling device (20) for introducing ambient air into the airbag (14), wherein the filling device (20) comprises at least one fan (16) with an electric motor (18), a first electric energy storage (22, 40), a second electric energy storage configured as capacitor (24), and a control device (26) for actuating the electric motor (18),
characterized in that
the control device (26) is configured to detect an activating of a standby mode of the filling device (20) and to effect a charging of the capacitor (24) with electric energy originating from the first energy storage (22, 40) depending on the activating of the standby mode.

2. Avalanche airbag system (10) according to claim 1,
characterized in that
a nominal capacity of the first energy storage (22, 40) is designed such that also after charging the capacitor (24) by using the electric energy of the first energy storage (22, 40) the airbag (14), in particular at an ambient temperature of up to −30 degrees Celsius, can be filled at least once.

3. Avalanche airbag system (10) according to claim 1 or 2,
characterized in that
the control device (26) is configured to effect, depending on the activating of the standby mode, the introduction of at least one charge quantity from the first energy storage (22, 40) into the capacitor (24), by means of which the airbag (14) can be filled at least once.

4. Avalanche airbag system (10) according to any one of claims 1 to 3,
characterized in that
the control device (26) is configured to effect, depending on a being-switched-on of the electric motor (18), the supplying of the electric motor (18) with electric energy originating from both energy storages (22, 40, 24).

5. Avalanche airbag system (10) according to any one of claims 1 to 4,
characterized in that
the control device (26) is configured to effect, depending on exceeding a predetermined threshold value of a power to be output by the electric motor (18) when filling the airbags (14), the supplying of the electric motor (18) with electric energy originating from both energy storages (22, 40, 24).

6. Avalanche airbag system (10) according to any one of claims 1 to 5,
characterized in that
the first energy storage (22, 40) comprises a non-rechargeable battery and/or an accumulator.

7. Avalanche airbag system (10) according to any one of claims 1 to 6,
characterized in that
the control device (26) is configured to effect an introduction of electric energy from the capacitor (24) into the first energy storage (40).

8. Avalanche airbag system (10) according to any one of claims 1 to 7,
characterized in that
the first energy storage (22, 40) serves for providing electric energy to the control device (26) and/or to further electronic components.

9. Avalanche airbag system (10) according to any one of claims 1 to 8,
characterized in that
the capacitor (24) is configured as supercapacitor and/or as lithium-ion capacitor.

10. Avalanche airbag system (10) according to any one of claims 1 to 9,
characterized in that
the capacitor (24) is arranged on a printed circuit board and is fixed in its position by means of a potting compound.

11. Avalanche airbag system (10) according to any one of claims 1 to 10,
characterized in that
an alarm device, which can be actuated by means of the control device (26) and which is configured to request a user of the avalanche airbag system (10) after a predetermined period of time has elapsed to recharge at least one of the energy storages (24, 40) and/or to replace at least one of the energy storages (22).

12. Avalanche airbag system (10) according to any one of claims 1 to 11,
characterized in that
an actuation device (36), by means of which the filling device (20) can be brought into a triggered state, in which the filling device (20) introduces ambient air into the airbag (14).

13. Carrying device, in particular backpack (12), comprising an avalanche airbag system (10) according to any one of the claims 1 to 12.

14. Method for operating an avalanche airbag system (10), which comprises at least one airbag (14) and a filling device (20), by means of which ambient air is introduced into the airbag (14), wherein the filling device (20) comprises at least one fan (16) with an electric motor (18), a first electric energy storage (22, 40), a second energy storage configured as capacitor (24), and a control device (26) which actuates the electric motor (18),
characterized in that
the control device (26) detects an activating of a standby mode of the filling device (20) and effects, due to the detection of the activating of the standby mode, a charging of the capacitor (24) with electric energy originating from the first energy storage (22, 40).
